(19) United States
(12) Patent Application Publication
(10) Pub. No.: US 2004/0007885 A1
(43) Pub. Date: Jan. 15, 2004

(54) SLIDING DOOR HANDLE HAVING AN INTEGRAL PUSH BUTTON LOCKING MECHANISM

(76) Inventor: Alex Michael, Toms River, NJ (US)

Correspondence Address: EZRA SUTTON, P.A., PLAZA 9, 900 ROUTE 9, WOODBRIDGE, NJ, 07095, US

(21) Appl. No.: 10/191,869

(22) Filed: Jul. 10, 2002

(51) Int. Cl. E05B 3/00

(52) U.S. Cl. 292/336.3

(57) ABSTRACT

The present invention provides an improved sliding door handle assembly having a spring operated integral push button locking mechanism. Specifically, the improved sliding door handle assembly is comprised of a handle assembly including an upper handle section and a lower handle section, and a push button assembly. The upper handle section is recessed so as to incorporate the push button assembly and includes an opening for insertion of a cylindrical locking pin. The locking pin is spring-biased so as to move between a first position for locking the handle and a second position for unlocking the handle. The lower handle section is curved to facilitate gripping the door handle.

The push button assembly includes a housing member and a push button member. The housing member has an opening to receive a push button member that is movable so as to engage and disengage the locking pin for locking and unlocking the handle

### FIELD OF INVENTION

The present invention relates to an improved sliding door handle having an integral push button locking mechanism.

### BACKGROUND OF THE INVENTION

Sliding doors are often locked by complex locking mechanisms that comprise many internal moving parts and thus are subject to disrepair. Also, the frame of sliding doors are not of a sufficient size to receive large and secure locking mechanisms. Therefore, there is a need for a mechanism to lock sliding doors that is secure, ergonomically efficient, simple to use, and requires only a minimal number of internal moving parts to withstand everyday wear and tear.

It is an object of the present invention to provide a sliding door handle having an integrated push button locking mechanism that is secure, efficient, durable, and easy to use.

### SUMMARY OF THE INVENTION

The present invention provides an improved sliding door handle assembly having a spring operated integral push button locking mechanism. Specifically, the improved sliding door handle assembly is comprised of a handle assembly including an upper handle section and a lower handle section, and a push button assembly. The upper handle section is recessed so as to incorporate the push button assembly and includes an opening for insertion of a cylindrical locking pin. The locking pin is spring-biased so as to move between a first position for locking the handle and a second position for unlocking the handle. The lower handle section is curved to facilitate gripping the door handle.

The push button assembly includes a housing member and a push button member. The housing member has an opening to receive a push button member that is movable so as to engage and disengage the locking pin for locking and unlocking the handle.

### BRIEF DESCRIPTION OF THE DRAWINGS

FIG. 1 is a perspective view of an improved sliding door handle, and sliding doors;

FIG. 2 is a cross sectional view of an improved sliding door handle;

FIG. 3 is a cross sectional view of an improved sliding door handle;

FIG. 4 is a perspective view of an improved sliding door handle;

FIG. 5 is an exploded perspective view of an improved sliding door handle;

FIG. 6 is a cross sectional view of the push button assembly of the improved sliding door handle in an unlocked position; and

FIG. 7 is a cross sectional view of the push button assembly of the improved sliding door handle in a locked position.

### DETAILED DESCRIPTION OF THE PREFERRED EMBODIMENT

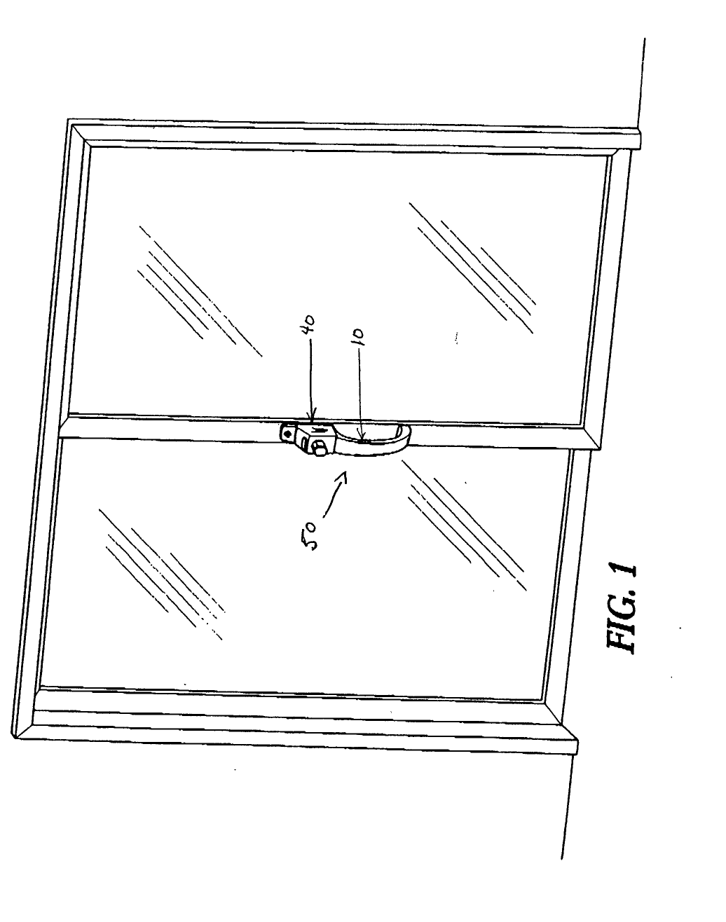

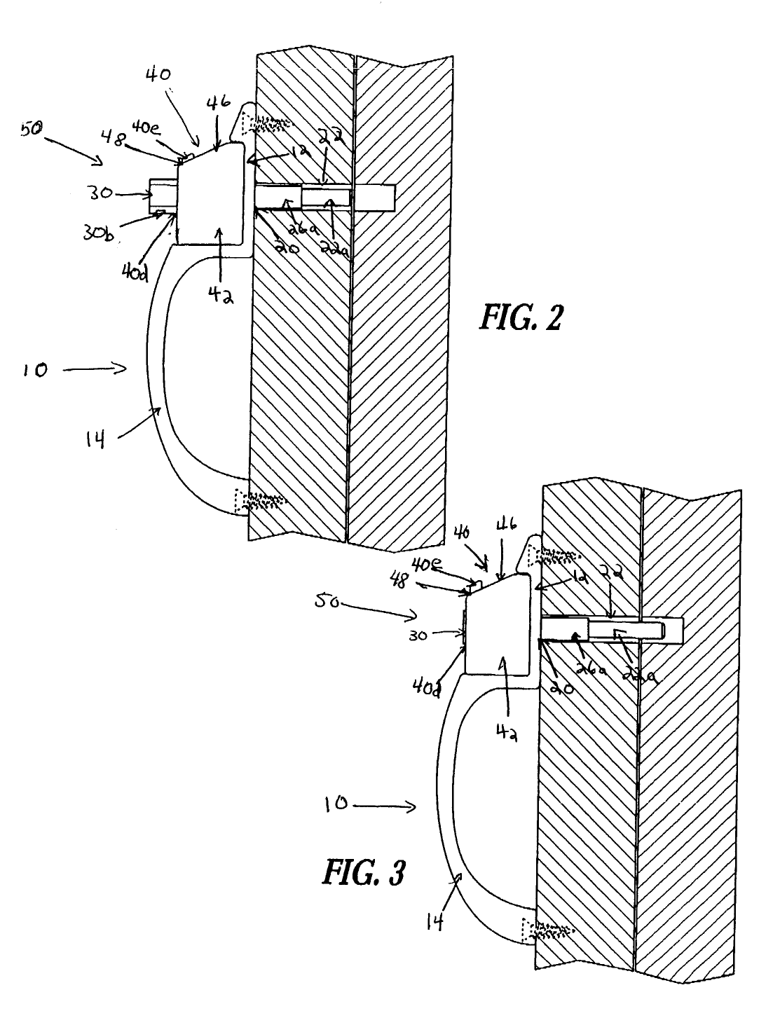

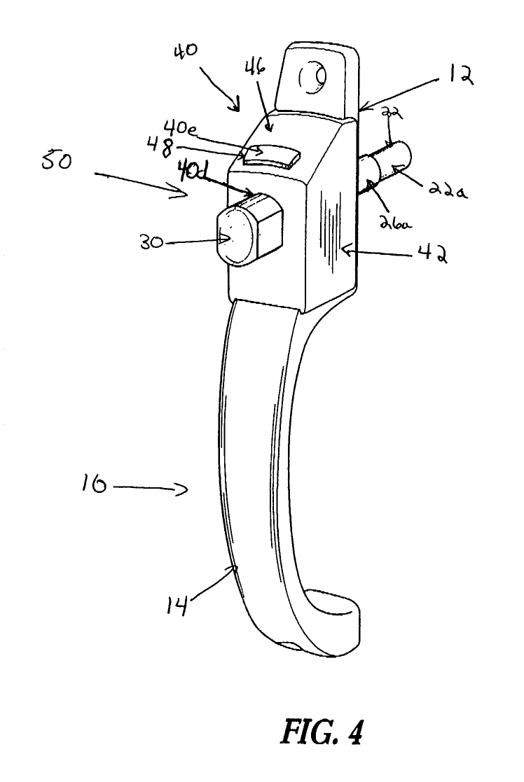

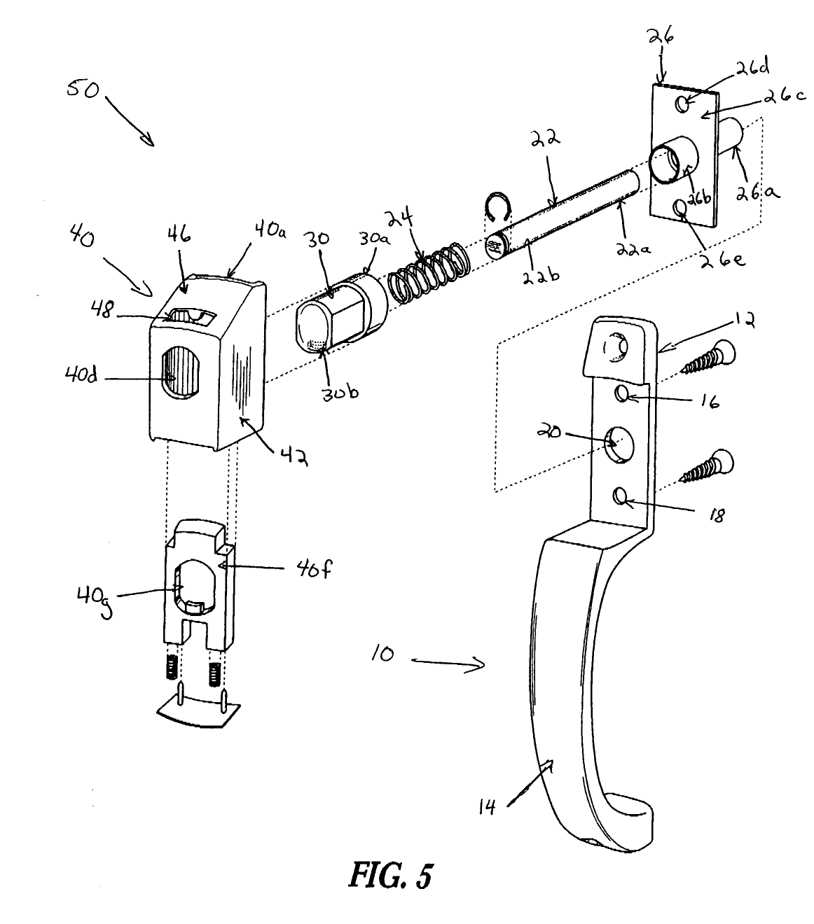

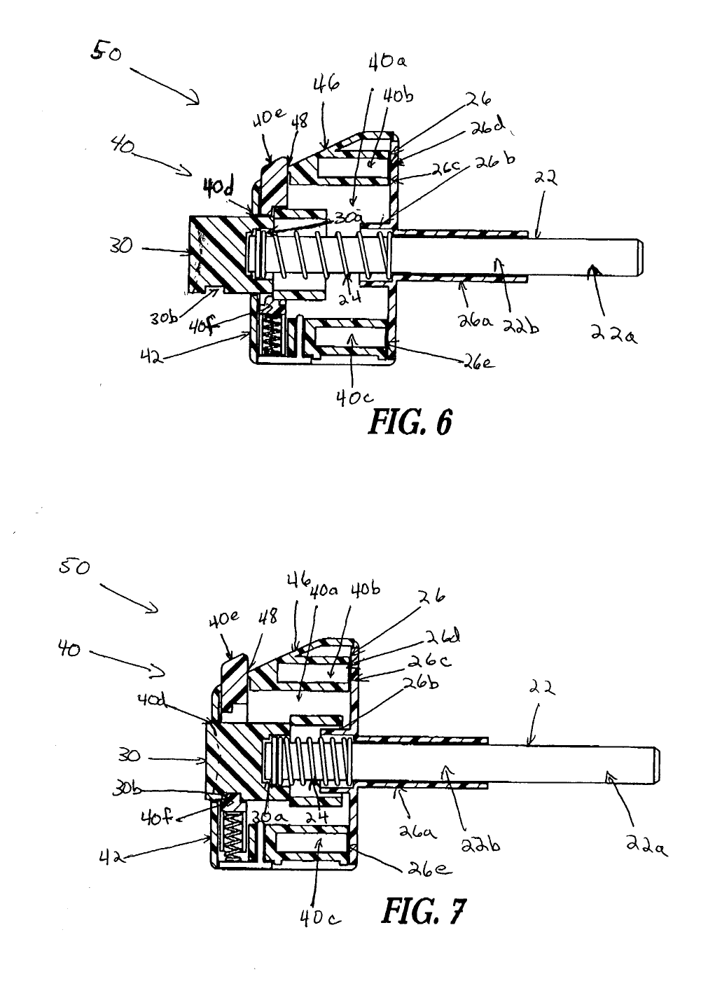

FIGS. 1 through 7 show an improved sliding door handle 50 having a handle assembly 10 and push button assembly 40.

The handle assembly 10 is comprised of an upper handle section 12 and a lower handle section 14. The upper handle section 12 is recessed so as to incorporate push button assembly 40. The upper handle section 12 has a central hole 20 with two equidistant screw holes 16 and 18 vertically above and below central hole 20 for securing the push button assembly 40 to upper handle section 12 of handle assembly 10.

Push button assembly 40 includes a cylindrical shaft 22 which fits into central hole 20 of upper handle section 12. Shaft 22 is comprised of an outer section 22a which acts as a locking pin and an inner section 22b which is enclosed in push button assembly 40. Spring 24 fits over inner section 22b and is compressible onto stop member 26. Stop member 26 is comprised of an outer section 26a that surrounds outer section 22a of shaft 22 and an inner section 26b that surrounds inner section 22b of shaft 22. The inner section 26b is integrally comprised of a vertical plate member 26c which is secured to upper handle section 12 by screws being inserted through holes 26d and 26e of plate member 26c.

Lower handle section 14 curves out to facilitate the gripping of handle assembly 10.

Push button assembly 40 is comprised of housing member 42 and push button housing 30 which includes a recess 30b for receiving locking member 40f Housing member 42 is rectangularly shaped with an internal cavity 40a and screw holes 40b and 40c so as to secure push button assembly 40 to handle assembly 10. Housing member 42 has an opening 40d to insert push button housing 30. The top section 46 of housing member 42, has a rectangular opening 48 which contains a vertically movable, rectangular button 40e which acts as the release for unlocking handle assembly 50 when depressed. Integral with rectangular button 40e and on the bottom portion 44 of opening 40d there is a vertically movable locking member 40f which moves upwardly to engage recess 30b. This activates the locking of handle assembly 50 when locking member 40f is in the upper position. Opening 40g is aligned with opening 40d.

Push button housing 30 has a depression for receiving a person's thumb and is horizontally inserted into opening 40d of push button assembly 40. Housing 30 contains an interior chamber 30a and locking slot 30b on its bottom section 32 which holds aforementioned locking member 40f when push button housing 30 is depressed, thus locking handle assembly 50.

A latitude of modification, change, and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1. An improved sliding door handle assembly having a spring operated integral push button locking mechanism, comprising:
a) a handle assembly including an upper handle section and a lower handle section, and a push button assembly;
b) said upper handle section including an opening foregoing;
c) a cylindrical locking pin for insertion into said opening;
d) said locking pin being spring-biased between a first position for locking said handle and a second position for unlocking said handle;
e) said lower handle section being curved to facilitate gripping said door handle;
f) said push button assembly including a push button housing and a push button member;
g) said push button housing having an opening for receiving said push button member therethrough and having a locking member for engaging said push button housing;
h) said push button housing having a recess for receiving said locking member which is movable between a locking position and an unlocking position.
